(19) United States
(12) Patent Application Publication
(10) Pub. No.: US 2003/0120750 A1
(43) Pub. Date: Jun. 26, 2003

(54) Device based detection of user preferences in a home networking environment

(76) Inventors: David Gaxiola, San Jose, CA (US); Joseph Alexander Dara-Abrams, Los Altos, CA (US); Ravi Gauba, Fremont, CA (US); Jun Ouyang, Sunnyvale, CA (US); Klaus Hofrichter, Santa Clara, CA (US)

Correspondence Address: Andre M. Gibbs, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/033,407

(22) Filed: Dec. 26, 2001

(51) Int. Cl. G06F 15/16; G06F 15/177

(52) U.S. Cl. 709/219; 709/220

(57) ABSTRACT

The provisioning of user preferences to a device or service is described. According to one embodiment of the invention, upon detecting a coupling of a device, a presumed user of the device is determined. The user preferences of the presumed user are retrieved and used to configure the device. In addition, particular services are loaded and unloaded from the device based on the user preferences of the presumed user of the device.

### FIELD OF THE INVENTION

The present invention relates generally to the provision of customized home network services. More particularly the invention relates to the provision of customized services based on the detection of user preferences.

### BACKGROUND

Traditionally, a consumer has been able to, to a limited extent, configure consumer electronic devices and computer systems. In some systems or devices, configurations or user preferences may be stored and later recalled. The configuration of a device, customized for a particular individual, usually involves some form of explicit identification. The explicit identification may take various forms, such as a user login to a computer, or the manual selection of the customized user preferences on a consumer electronic device.

However, often times there is an implied ownership of a device. For example, in a home network, the entire family may share a particular device or service, such as, a TV, DVD player, or stereo system. Typically one device is operated by a particular family member at any one time, and others often have to manually reset or recall user preferences associated with multiple devices on the network each and every time they are used. Hence, these home network devices lack a means of taking advantage of implied ownership by automatically recalling or customizing the settings when specific users use specific devices coupled to the network.

### SUMMARY OF THE INVENTION

This invention discloses the provisioning of user preferences to a device or service. According to one embodiment of the invention, upon detecting a coupling of a device to a home network, a presumed user of the device is determined. The user preferences of the presumed user are retrieved and used to configure the device. In addition, particular services are loaded and unloaded from the device based on the user preferences of the presumed user of the device.

### BRIEF DESCRIPTION OF THE DRAWINGS

The present invention is illustrated by way of example and not intended to be limited by the figures of the accompanying drawings in which like references indicate similar elements and in which:

FIG. 1 shows a system architecture of one embodiment of the present invention.

FIG. 2 illustrates a flow diagram of one embodiment of a configuration method performed by the custom settings manager of FIG. 1.

FIG. 3 shows functionalities of one embodiment of a custom settings manager of FIG. 1.

FIG. 4 shows an exemplary processing system in which the present invention may be implemented.

### DETAILED DESCRIPTION

The provisioning of user preferences to a device or service is described. According to one embodiment, the user of a device (e.g., a consumer electronic device) is not explicitly known when the device is coupled to a home network. When a user couples a particular device to a home network, a specific user is presumed and the user preferences of the presumed user are used to reconfigure the coupled device or service of the device.

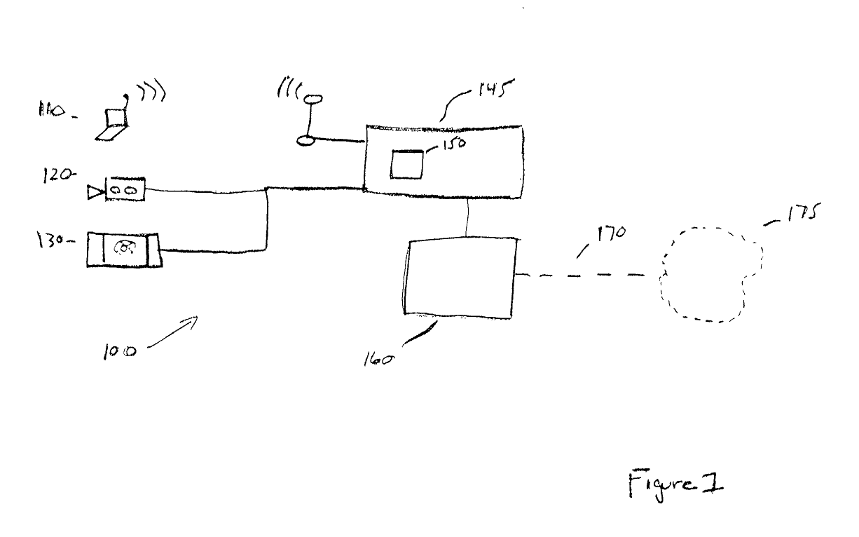

FIG. 1 illustrates one embodiment of a home network in which a shared network access device 160, a set top box 145, and multiple consumer electronic devices 110, 120, 130, are coupled to the home network 100. The shared network access device 160 is a network access device that is shared by devices on the home network 100 and may be further coupled (as shown in phantom 170) to an external network (as shown in phantom 175), such as cable, satellite, or the Internet. The shared network access device 160 may include a television, a DVD player, a stereo system, a cable set top box, or other processing system that presents programming, such as broadcast programming, programming on media, and/or programming received from the external network(s) based on the user preferences described further below. In one embodiment, the shared network access device 160 and set top box 145 are physically combined into one device.

In addition, the home network 100 may provide one or more services to the devices 110, 120, 130 coupled to the network. A service may be an application that is accessible by a user locally on a directly connected device, or remotely across a network. For example, a user may prefer using a particular service (e.g., a graphical editing service) when utilizing a particular device (e.g., a graphics tablet). The service may be embodied as code or data, used or executed by the coupled device or another device, such as the set top box 145.

In one embodiment, a custom settings manager 150 detects the coupling of a device to the home network 100 and provides the necessary services. The devices themselves do not broadcast owner/user information to the home network 100, therefore, the custom settings manager 150 maps services for a presumed user of the device from between one or more user preferences, as will be described. Upon detecting the presence of a device on the home network 100, the custom settings manager 150 may perform one or more of the functions as follows: (1) map known ownership of a device to one or more users; (2) determine the presence of a particular user based on the presence of particular devices and services; (3) change the configuration of the services and devices based on presumed ownership of the services and devices; (4) change environmental settings, (such as a visual arrangement on a display, sound levels, and actual information presented) based on the user presumed to be using the device; (5) select content availability (for example, broadcasts of programs) based on the presumed user; and/or (6) select the appropriate configuration options based on combinations of devices and services in use at a particular time. When the custom settings manager 150 detects the presence of a device, a sequence of configuration actions begin as will be further described.

Devices 110, 120, 130 may be directly or indirectly coupled to the home network 100. The devices 110, 120, 130 are illustrated as a cellular telephone 110, a digital camera 120, or a digital audio player 130, but the invention is not so limited. The custom settings manager 150 communicates with devices 110, 120, 130 through the home network 100 by optical, wired, or wireless transmission, among other examples. Eventually, any of the devices 110 through 130 are associated with a user along with the associated user preferences for this specific service or device. As will be further described below, the user preferences are used to customize the device and any associated devices and services coupled to the network.

For example, User A and User B may both use the same graphics editing service on the home network 100. However, User A uses the service to perform graphical editing with a high-end combination graphics tablet device and User B uses the graphics editing service but with a Personal Digital Assistant (PDA) device as an input device. Multiple users share both of these devices. When User A couples the graphics tablet to the home networking environment 100 (e.g., plugging it into a cradle coupled to the home network 100) a sequence of configuration actions begins as follows. The custom settings manager 150 detects the new graphics tablet and determines a specific user to be associated with the device. If it is determined that User A is the presumed user of the device, the graphics editing service is started for User A and the custom setting manager 150 automatically sets the user preferences, to apply, for example, the service-preferred toolset, last edited images, and the color palette on the device.

Later, User B arrives and connects the PDA to the home network 100. Again, the graphics editing service is launched. In this case, the custom settings manager 150 presumes User B to be the user and configures the graphics editing service to the preferred user preferences of User B's own preferred toolset, image editing list, and color palette.

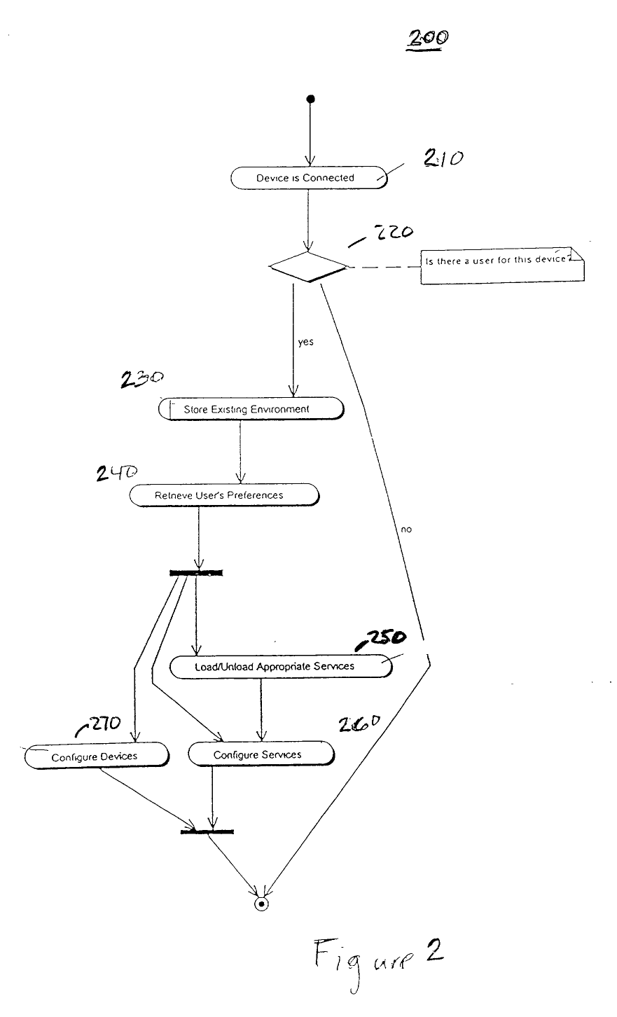

FIG. 2 shows a flow diagram of an embodiment of a configuration method performed by the customer settings manager 150 in accordance with the present invention. At block 210, a device is coupled to the home network 100. The connection may be made by conventional means (wired, wireless, optical connection, etc) using a variety of available protocols.

At decision block 220, the custom settings manager 150 determines whether or not the system has stored user preferences for at least one user of the device connected in block 210. If there is at least one user for the device has been identified, control passes to block 230. If there is not at least one user for the device, no predetermined user preferences are loaded.

At block 230, if at least one user for the device has been identified, the existing configuration for the device is stored, so as to restore the system to the previously known state at a later point in time (e.g., when the device is removed from the home network 100). The existing configuration may be stored in the custom settings manager 150 or the device itself. At block 240, the user preferences of the presumed user of the coupled device are retrieved. In one embodiment, the user preferences are stored in a database as will be further described below.

At block 250, appropriate services are unloaded through an interface on the device or through an alternate device, such as a controller or computing device coupled to the network, if needed. The decision to unload services may be to remove unnecessary services from the device. In one embodiment, the custom settings manager 150 determines whether a device has enough storage space to load a requested service. The device may include a temporary or persistent data store to store various services to be used by the users of the device. If the custom settings manager 150 determines that a device does not have enough storage space within the data store, then other services that are not needed will be unloaded from the device before the loading of the requested service. This process is further described in the patent application entitled “Remote Resource Management of Local Devices”, attorney reference number 080398.P453, Ser. No. ______, Filed ______, and Assigned to ______. In the ______ application, a service may be selected to be unloaded due to a variety of factors, for example, the least frequently used service or the service that conflicts with other services or devices (e.g., old version of service).

At block 260, the appropriate services are loaded, if necessary, and configured. Again, the loading and configurations are based on the retrieved user preferences. At block 270, any additional device(s) or service(s) identified in the user preferences are configured.

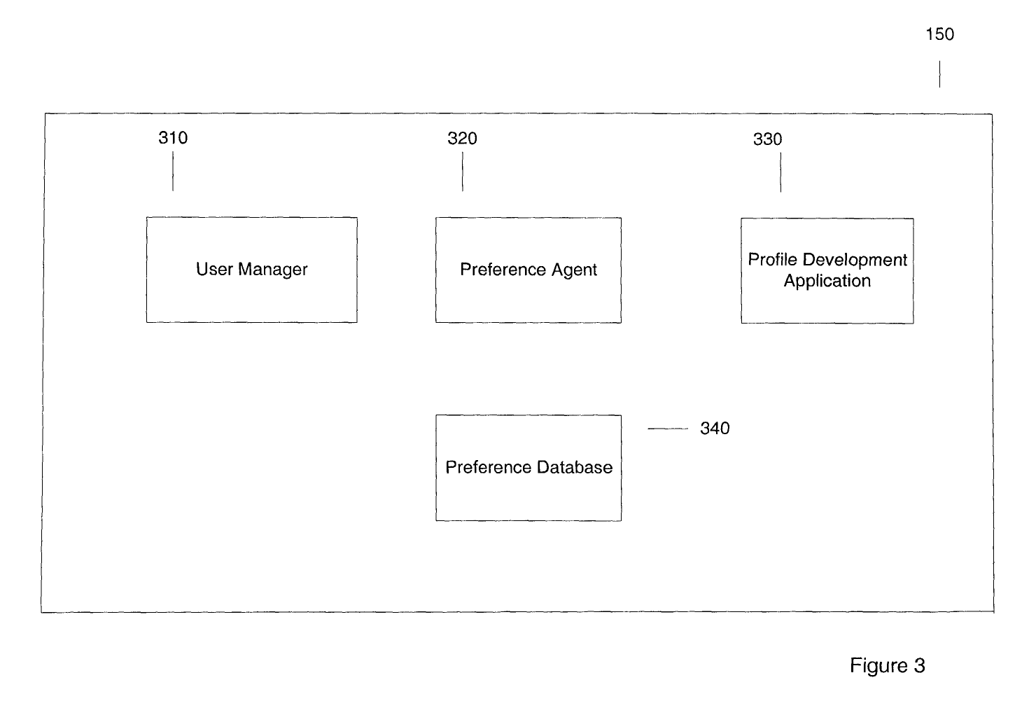

FIG. 3 shows exemplary functionalities of the custom settings manager. FIG. 3 shows one embodiment that includes a preference database 340, a user manager 310, a profile development application 330, and a preference agent 320.

The preference database 340 stores a user profile for each user of the home network 100. Each user profile contains user preferences information for each device and/or service. As stated above, user preferences are used to customize specific devices and services on the home network 100.

The user manager 310 detects the presence of a new device on the network. The user manager 310 associates a specific user to a newly coupled device. Specifically, the user manager 310 identifies the device, queries the preference database 340 for the users for the device, and presumes one of these users to be the actual user of the device. The user manager 310 retrieves the user preferences of the presumed user and uses these user preferences to configure the coupled device.

In addition, one or more of the other services and/or devices on the home network 100 may also be configured. Continuing the previous example, upon retrieving the user preferences of User A to customize the graphics editing service on the coupled graphics tablet, the user preferences may also be used to have the audio player device play specific music and the television to display specific video while User A is using the graphics editing service.

In one embodiment, the profile development application 330 determines the presumed user of the coupled device based on user usage patterns on the home network 100. The profile development application 330 monitors specific user behavior on the home network 100, such as, the user preference often used in combination with other devices and services by the user. The profile development application 330 stores these user preferences in the specific user profile for each associated user. When the device is later coupled with the home network 100, the user manager 310 reconfigures the devices and services based on these stored usage patterns.

In another embodiment, the user manager 310 determines the presumed user of the device by examining the other devices and services currently coupled to the home network 100. The user manager 310 determines whether it is apparent from the currently coupled combination of services and devices which user has coupled the device. This may be achieved by comparing the currently coupled devices and services to each user's profile and identifying the user preferences stored in preference database 340 that best match the newly coupled device.

In still another embodiment, the user manager 310 determines the presumed user to be the user to have used most recently the device. Regardless of the manner the user manager 310 selects a presumed user, if the user manager 310 selects the wrong user, the user is able to modify the device or server, and select the correct user.

In one embodiment, after the user manager 310 determines the presumed user of the device, a preference agent 320 is instantiated. The preference agent 320 applies the customized user preferences of the presumed user of the device to the associated service or device. Therefore, in the example given above, when the tablet is coupled to the home network 100 and the user manager 310 presumes the user to be User A, then a preference agent is instantiated that configures the graphics tablet device per User A's user preferences. Also, when User B's PDA is detected to be coupled to the home network 100, then another preference agent is instantiated that configures the user preferences for the PDA User B.

In one embodiment, the user manager 310 is not used but a device accesses the preference database 340 directly for user preferences, in contrast to the preference agent 320 accessing the preference database 340.

It should be understood that the invention is not limited to the described embodiments of determining the presumed user of a device and applying the necessary customized user preferences. Alternatively, other embodiments may be used within the scope of the invention that has not been described in detail in order to avoid unnecessarily obscuring the invention.

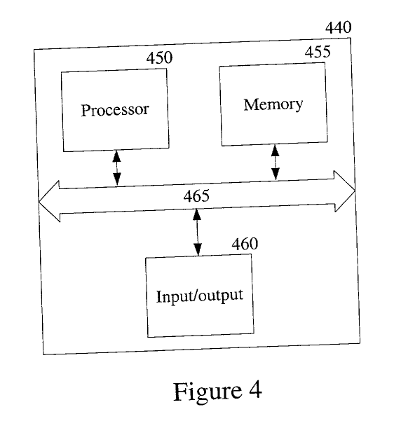

One embodiment of a computer system suitable for the provisioning of user profile information is illustrated in FIG. 4. The computer system 440 includes a processor 450, memory 455 and input/output capability 460 coupled to a system bus 465. The memory 455 is configured to store instructions which, when executed by the processor 450, perform the methods described herein. The memory 455 may also store the existing configuration settings and user profiles containing various user preferences. Input/output 460 provides for the delivery and display of a service to a device and allows for the modification of the user profiles and user preferences thereof. Input/output 460 also encompasses various types of machine-readable media, including any type of storage device (e.g., preference database 340) that is accessible by the processor 450.

The description of FIG. 4 is intended to provide an overview of computer hardware and other operating components suitable for implementing the invention, but is not intended to limit the applicable environments. It will be appreciated that the computer system 440 is one example of many possible computer systems which have different architectures. A typical computer system will usually include at least a processor, memory, and a bus coupling the memory to the processor. One of skill in the art will immediately appreciate that the invention can be practiced with other computer system configurations, including multiprocessor systems, minicomputers, mainframe computers, and the like. The invention can also be practiced in distributed computing environments where tasks are performed by remote processing devices that are linked through a communications network.

It will be appreciated that that more or fewer processes may be incorporated into the method(s) illustrated in FIGS. 2 without departing from the scope of the invention and that no particular order is implied by the arrangement of blocks shown and described herein. It further will be appreciated that the method(s) described in conjunction with FIGS. 2 may be embodied in machine-executable instructions, e.g. software. The instructions can be used to cause a general-purpose or special-purpose processor that is programmed with the instructions to perform the operations described. Alternatively, the operations might be performed by specific hardware components that contain hardwired logic for performing the operations, or by any combination of programmed computer components and custom hardware components. The methods may be provided as a computer program product that may include a machine-readable medium having stored thereon instructions that may be used to program a computer (or other electronic devices) to perform the methods. For the purposes of this specification, the terms “machine-readable medium” shall be taken to include any medium that is capable of storing or encoding a sequence of instructions for execution by the machine and that cause the machine to perform any one of the methodologies of the present invention. The term “machine-readable medium” shall accordingly be taken to included, but not be limited to, solid-state memories, optical and magnetic disks, and a carrier wave that encodes a data signal. Furthermore, it is common in the art to speak of software, in one form or another (e.g., program, procedure, process, application, module, logic . . . ), as taking an action or causing a result. Such expressions are merely a shorthand way of saying that execution of the software by a computer causes the processor of the computer to perform an action or a produce a result.

In the foregoing specification, the invention has been described with reference to specific exemplary embodiments thereof. It will however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method of provisioning user preferences comprising:
detecting a coupling of a device to a network;
identifying a user corresponding to the device; and
configuring the device according to user preferences associated with the identified user.

2. The method of claim 1 wherein the device includes a service.

3. The method of claim 2 wherein the configuring includes configuring the service.

4. The method of claim 1 wherein the identifying comprises identifying the user by user usage patterns.

5. The method of claim 1 wherein the identifying a user corresponding to the device is determined by examining other devices and services on the network.

6. The method of claim 1 wherein the identifying comprises identifying the corresponding user to be a user who has most recently used the device.

7. The method as set forth in claim 2, further comprising unloading another service according to the user preferences.

8. The method as set forth in claim 2, further comprising loading the service according to the user preferences of the identified user.

9. The method of claim 1 wherein the identifying comprises querying a data store which associates a set of devices and identities of users of the set of devices.

10. A machine-readable medium having executable instructions to cause a machine to perform a method comprising:
detecting a coupling of a device to a network;
identifying a user corresponding to the device; and
configuring the device according to user preferences associated with the identified user.

11. The machine-readable medium of claim 10 wherein the device includes a service.

12. The machine-readable medium of claim 11 wherein the configuring includes configuring the service.

13. The machine-readable medium of claim 10 wherein the identifying comprises identifying the user by user usage patterns.

14. The machine-readable medium of claim 10 wherein the identifying a user corresponding to the device is determined by examining other devices and services on the network.

15. The machine-readable medium of claim 10 wherein the identifying comprises identifying the corresponding user to be a user who has most recently used the device.

16. The machine-readable medium as set forth in claim 10, further comprising unloading another service according to the user preferences.

17. The machine-readable medium as set forth in claim 11, further comprising loading the service according to the user preferences of the identified user.

18. The machine-readable medium of claim 10 wherein the identifying comprises querying a data store which associates a set of devices and identities users of the set of devices.

19. A system comprising:
a device selectively coupled through a network;
a user profile comprising user preferences of the associated user for the device; and
a custom setting manager to associate a user to the device and further to access the user profile when the device is coupled to the network and configure the device according to the user preferences.

20. The system of claim 19 wherein the user is associated to the device by user usage patterns.

21. The system of claim 19 wherein the user is associated to the device by examining the other devices and services on the network.

22. The system of claim 19 wherein the user is associated to the last user of the device.

23. The system of claim 19, wherein the user profile further comprises:
an association between the user and the device.

24. The system of claim 19, further comprising:
a user manager to detect when the device is coupled.

25. A system comprising:
a network;
a plurality of devices selectively coupled through the network; and
a custom settings manager configured to identify the user of the device and further to access user preferences associated with the user and selectively configure devices based upon the user preference associated with the user.

26. The system of claim 25 wherein the identifying the user comprises identifying the user from the user usage patterns.

27. The system of claim 25 wherein the identifying the user comprises identifying the user by examining the other devices and services currently coupled to the network.

28. The system of claim 25 wherein the identifying the user comprises identifying the user to be a user who has most recently used the device.

29. The system of claim 25 further comprising:
a user manager that detects a coupling of a device to the network.

30. The system of claim 25, wherein the identification is accomplished by querying a preferences database.

31. The system of claim 25, wherein the accessing and configuring are performed by a preference agent.

32. The system of claim 25 where the plurality of devices includes a service, the service to be identified in the user preferences.
